(19) United States
(12) Patent Application Publication
(10) Pub. No.: US 2023/0132844 A1
(43) Pub. Date: May 4, 2023

(54) DETERMINATION DEVICE AND DETERMINATION METHOD

(71) Applicant: KABUSHIKI KAISHA TOKAI RIKA DENKI SEISAKUSHO, Aichi (JP)

(72) Inventor: Masanori KOSUGI, Aichi (JP)

(73) Assignee: KABUSHIKI KAISHA TOKAI RIKA DENKI SEISAKUSHO, Aichi (JP)

(21) Appl. No.: 17/963,430

(22) Filed: Oct. 11, 2022

(30) Foreign Application Priority Data
Oct. 28, 2021 (JP) 2021-176283

(51) Int. Cl. H04W 16/28; H04B 7/0408

(52) U.S. Cl. CPC H04W 16/28; H04B 7/0408

(57) ABSTRACT

There is provided a determination device comprising a determination section configured to determine a direction of a position of an external device on a basis of a synthetic radio wave obtained by combining a first radio wave and a second radio wave, the first radio wave being transmitted from the external device and received by a first antenna, the second radio wave being transmitted from the external device and received by a second antenna, wherein delay between the first radio wave and the second radio wave is designed to be about ¼ wavelength before generating the synthetic radio wave, and the second radio wave is further delayed by about ½ wavelength.

### CROSS REFERENCE TO RELATED APPLICATION(S)

This application is based upon and claims benefit of priority from Japanese Patent Application No. 2021-176283, filed on Oct. 28, 2021, the entire contents of which are incorporated herein by reference.

### BACKGROUND

The present invention relates to a determination device and a determination method.

In recent years, technologies of estimating a direction of arrival of a radio wave have been developed. Sometimes a passive phased array antenna or the like may be used for estimating the direction of arrival of the radio wave. For example, JP 2009-081674A discloses a technology related to beam steering using the passive phased array antenna.

### SUMMARY

However, in the case of using the passive phased array antenna as disclosed in JP 2009-081674A, an expensive phase shifter is necessary, and the configuration gets complicated. Therefore, the configuration disclosed in JP 2009-081674A is excessive in the case where high accuracy is not required for estimating the direction of arrival of the radio wave.

Accordingly, the present invention is made in view of the aforementioned issues, and an object of the present invention is to determine a direction of arrival of a radio wave by using a simpler configuration.

To solve the above described problem, according to an aspect of the present invention, there is provided a determination device comprising a determination section configured to determine a direction of a position of an external device on a basis of a synthetic radio wave obtained by combining a first radio wave and a second radio wave, the first radio wave being transmitted from the external device and received by a first antenna, the second radio wave being transmitted from the external device and received by a second antenna, wherein delay between the first radio wave and the second radio wave is designed to be about ¼ wavelength before generating the synthetic radio wave, and the second radio wave is further delayed by about ½ wavelength.

To solve the above described problem, according to another aspect of the present invention, there is provided a determination method comprising determining a direction of a position of an external device on a basis of a synthetic radio wave obtained by combining a first radio wave and a second radio wave, the first radio wave being transmitted from an external device and received by a first antenna, the second radio wave being transmitted from the external device and received by a second antenna, wherein delay between the first radio wave and the second radio wave is designed to be about ¼ wavelength before generating the synthetic radio wave, and the second radio wave is further delayed by about ½ wavelength.

As described above, according to the present invention, it is possible to determine a direction of arrival of a radio wave by using a simpler configuration.

### BRIEF DESCRIPTION OF THE DRAWINGS

FIG. 1 is a diagram for describing an example of determining a direction of arrival of a radio wave according to a first embodiment of the present invention.

FIG. 2 is a diagram illustrating a configuration example of a determination device 10 according to the embodiment.

FIG. 3 is a diagram for describing a synthetic radio wave obtained in the case where an external device 60 is positioned on a first antenna 110 side (inside a room) according to the embodiment.

FIG. 4 is a diagram for describing a synthetic radio wave obtained in the case where the external device 60 is positioned on a second antenna 120 side (outside the room) according to the embodiment.

FIG. 5 is a diagram for describing an example of determining a direction of arrival of a radio wave according to a second embodiment of the present invention.

FIG. 6 is a diagram illustrating a configuration example of the determination device 10 according to the embodiment.

FIG. 7 is a diagram for describing a synthetic radio wave obtained in the case where the external device 60 is positioned in a direction along a first axis A1 (inside or outside the room) according to the embodiment.

FIG. 8 is a diagram for describing a synthetic radio wave obtained in the case where the external device 60 is positioned in a direction along a second axis A2 (upper side or lower side) according to the embodiment.

FIG. 9 is a diagram illustrating a case where a first antenna 110 and a second antenna 120 according to the embodiment are disposed on a ceiling of a vehicle 50.

FIG. 10 is a diagram illustrating a configuration example of a determination device 10 according to a third embodiment of the present invention.

FIG. 11 is a diagram illustrating a configuration example of a determination device 10 according to a fourth embodiment of the present invention.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. First Embodiment

The above-described passive phased array antenna or the like is capable of detecting a direction of arrival of a radio wave with high accuracy.

On the other hand, the passive phased array antenna that needs the expensive phase shifter is excessive and unnecessary if it is sufficient to determine which one of two conflicting directions a radio wave is arrived from.

The technical idea of an embodiment of the present invention was conceived by focusing on the above-described points, and makes it possible to simply determine a direction of arrival of a radio wave without using an expensive component such as the phase shifter.

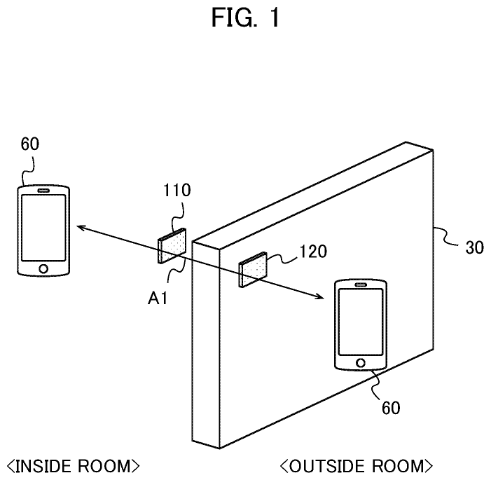

FIG. 1 is a diagram for describing an example of determining a direction of arrival of a radio wave according to a first embodiment of the present invention.

In this example, it is assumed that the determination device 10 according to the present embodiment determines a direction of a position of an external device 60 with reference to a partition 30.

Here, the external device 60 is a device configured to transmit radio waves compliant with a designated communication standard.

Examples of the designated communication standard include Bluetooth Low Energy (BLE) (registered trademark) and the like.

For example, the external device 60 may be a smartphone, a tablet, or the like.

On the other hand, the partition 30 may be a structure such as a door or a wall.

In this case, the determination device 10 according to the present embodiment determines the direction of the position of the external device 60 on the basis of radio waves received by the first antenna 110 and the second antenna 120 that are disposed across the partition 30.

More specifically, a determination section 180 of the determination device 10 according to the present embodiment determines the direction of the position of the external device 60 on the basis of a synthetic radio wave obtained by combining a first radio wave and a second radio wave, the first radio wave being transmitted from the external device 60 and received by the first antenna 110, the second radio wave being transmitted from the external device 60 and received by the second antenna 120.

For example, on the basis of the synthetic radio wave, the determination section 180 of the determination device 10 according to the present embodiment may determine whether the external device 60 is positioned on the first antenna side or on the second antenna side along a first axis A1 connecting the first antenna 110 to the second antenna 120.

In the example illustrated in FIG. 1, the first antenna 110 is disposed inside a room with reference to the partition 30 disposed in a house or the like, and the second antenna 120 is disposed outside the room with reference to the partition 30 disposed in the house or the like.

In this case, the determination section 180 according to the present embodiment may determine whether the external device 60 is positioned inside or outside the room on the basis of radio waves received by the first antenna 110 and the second antenna 120.

To make a determination as described above, both the first antenna 110 and the second antenna 120 have to receive the radio waves transmitted from the external device 60.

Accordingly, the partition 30 may be formed of material that is transparent to the radio waves that are transmitted from the external device 60 in conformity with the designated communication standard.

However, the material used for the partition 30 is not limited thereto in the case where the partition 30 is capable of diffracting the radio waves transmitted from the external device 60.

In addition, the first antenna 110 and the second antenna 120 do not have to be disposed across the partition 30. For example, the second antenna 120 may be disposed near a door inside the room in the case of determining whether or not the external device 60 is positioned inside or outside the room. In addition, the results of the determination according to the present embodiment are not limited to the result indicating an inside of the room and the result indicating an outside of the room.

In addition, one of features of the determination device 10 according to the present embodiment is to design delay between the first radio wave and the second radio wave to be about ¼ of wavelength λ before generating the synthetic radio wave.

For example, the above-described feature is achieved when the first antenna 110 and the second antenna 120 are disposed in such a manner that a physical (or spatial) distance between the first antenna 110 and the second antenna becomes λ/4.

However, the physical distance between the first antenna 110 and the second antenna does not have to become λ/4. It is sufficient to achieve the above-described feature by adding a delay line.

For example, in the case where the physical distance between the first antenna 110 and the second antenna 120 is λ/8, it is sufficient to add a delay line in such a manner that a difference between a transmission line of the first antenna 110 and a transmission line of the second antenna 120 becomes λ/8. In this case, a sum of the physical distance and the delay line is λ/4.

Alternatively, for example, it is also assumed that the physical distance between the first antenna 110 and the second antenna is λ/2. In this case, a delay line may be added in such a manner that a difference between the transmission line of the first antenna 110 and the transmission line of the second antenna 120 becomes 3λ/4. In this case, a sum of the physical distance and the delay line is λ/4+nλ (note that, n represents 0 or a natural number. In this example, n=1), and the above-described feature is achieved.

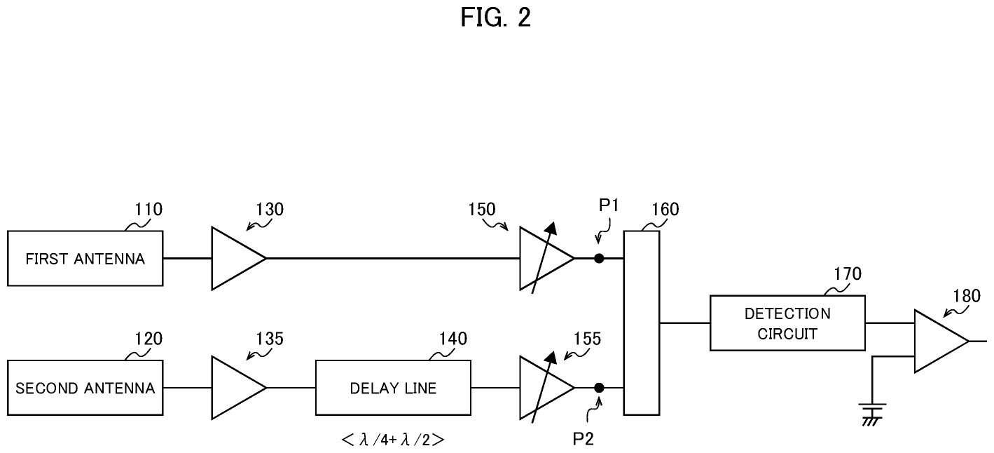

Next, details of the configuration example for making the above-described determination according to the present embodiment will be described with reference to FIG. 2.

FIG. 2 is a diagram illustrating the configuration example of the determination device 10 according to the present embodiment.

In the example illustrated in FIG. 2, the determination device 10 includes the first antenna 110, the second antenna 120, amplification circuits 130 and 135, a delay line 140, a first wave height adjustment circuit 150, a second wave height adjustment circuit 155, a synthesis circuit 160, a detection circuit 170, and the determination section 180.

As described above, the first antenna 110 and the second antenna 120 according to the present embodiment receive radio waves transmitted from the external device 60 in conformity with the designated communication standard. To simplify the explanation, the present example assumes that the first antenna 110 and the second antenna 120 are disposed in such a manner that the physical distance between the first antenna 110 and the second antenna is λ/4.

The amplification circuit 130 according to the present embodiment amplifies a first radio wave received by the first antenna 110, and the amplification circuit 135 according to the present embodiment amplifies a second radio wave received by the second antenna 120.

The delay line 140 according to the present embodiment further delays the second radio wave received by the second antenna 120. In the present example, delay between the first radio wave and the second radio wave are designed to be about ¼ of the wavelength λ, and the delay line 140 further delays the second radio wave by about (¼+½) of the wavelength λ.

The first wave height adjustment circuit 150 according to the present embodiment has a function of adjusting the wave height of the first radio wave to a designated wave height, and the second wave height adjustment circuit 155 according to the present embodiment has a function of adjusting the wave height of the second radio wave to a designated wave height.

The adjustment functions of the first wave height adjustment circuit 150 and the second wave height adjustment circuit 155 may be achieved through automatic gain control (AGC), for example. Sometimes the AGC is also referred to as automatic level control (ALC).

The synthesis circuit 160 according to the present embodiment combines the first radio wave and the second radio wave, and generates a synthetic radio wave.

The detection circuit 170 according to the present embodiment extracts a direct current (DC) component of the synthetic radio wave.

The determination section 180 according to the present embodiment determines a direction of a position of the external device 60 on the basis of the synthetic radio wave.

As an example, the determination section 180 according to the present embodiment may make the above-described determination by comparing the DC component to a designated value. The DC component is extracted from the synthetic radio wave by the detection circuit 170. In this case, the determination section 180 may be implemented as a comparator.

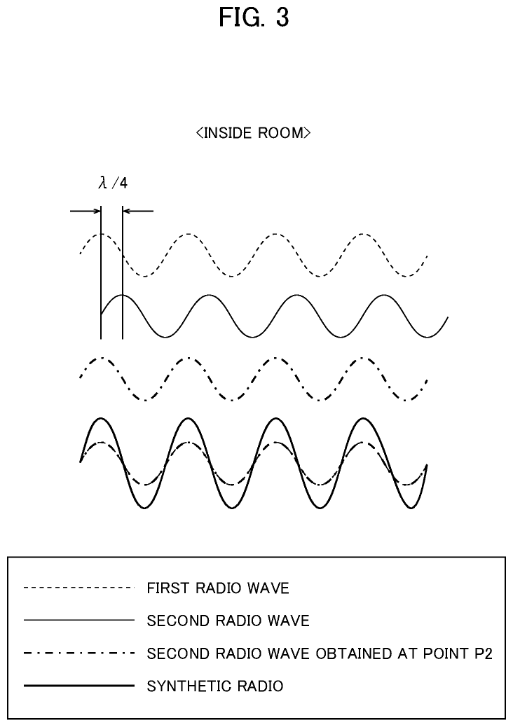

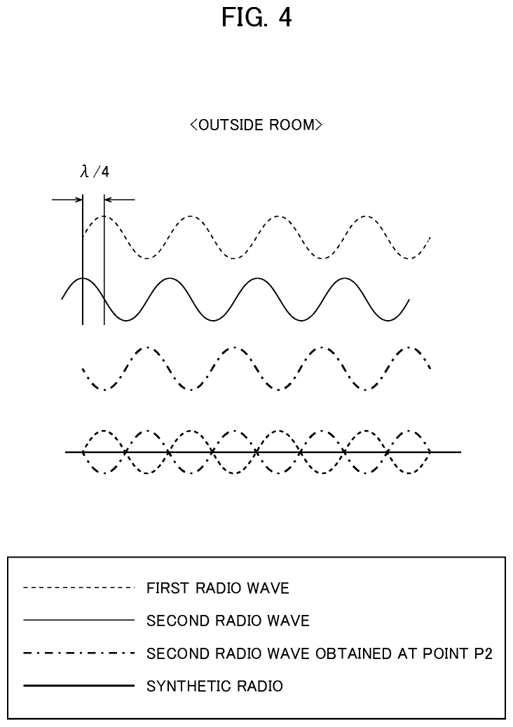

The configuration example of the display device 10 according to the present embodiment has been described above. Next, details of an example of the determination according to the present embodiment will be described with reference to FIG. 3 and FIG. 4.

FIG. 3 is a diagram for describing a synthetic radio wave obtained in the case where the external device 60 is positioned on the first antenna 110 side (inside the room) under the conditions illustrated in FIG. 1 and FIG. 2.

In addition, FIG. 4 is a diagram for describing a synthetic radio wave obtained in the case where the external device 60 is positioned on the second antenna 120 side (outside the room) under the conditions illustrated in FIG. 1 and FIG. 2.

Note that, to simplify the explanation, FIG. 3 and FIG. 4 assume that the radio waves have a same wave height. As described above, there is no divergence from the assumption because the first wave height adjustment circuit 150 and the second wave height adjustment circuit 155 adjust the wave height of the first radio wave and the wave height of the second radio wave to certain wave heights before synthesis.

First, description will be given with reference to FIG. 3. In the case where the external device 60 is positioned inside the room, the first antenna 110 closer to the external device 60 first receive a radio wave, and then the second antenna 120 receives a radio wave.

Therefore, as illustrated in FIG. 3, the second radio wave is delayed behind the first radio wave by λ/4.

In addition, in this example, the delay line 140 further delays the second radio wave by λ/2.

Therefore, the second radio wave obtained at a point P2 illustrated in FIG. 2 has substantially the same phase as the first radio wave obtained at a point P1. The first radio wave obtained at the point P1 has no delay.

Accordingly, the wave height of a synthetic radio wave generated by the synthesis circuit 160 is about twice as high as the wave height of the first radio wave obtained at the point P1 and the wave height of the second radio wave obtained at the point P2 as illustrated in FIG. 3.

On the other hand, in the case where the external device 60 is positioned outside the room, the second antenna 120 closer to the external device 60 first receive a radio wave, and then the first antenna 110 receives a radio wave.

Therefore, as illustrated in FIG. 4, the first radio wave is delayed behind the second radio wave by λ/4.

Note that, in this example, the delay line 140 delays the second radio wave by λ/4+λ/2.

Therefore, the second radio wave obtained at the point P2 illustrated in FIG. 2 has a phase that is almost reverse of the first radio wave obtained at the point P1.

Accordingly, the wave height of a synthetic radio wave generated by the synthesis circuit 160 is about zero as illustrated in FIG. 4.

Therefore, it is possible for the determination section 180 according to the present embodiment to determine that the external device 60 is positioned on the second antenna 120 side (outside the room in this example) along the first axis A1 in the case where the synthetic radio wave has a wave height that falls below a designated wave height.

On the contrary, it is also possible for the determination section 180 according to the present embodiment to determine that the external device 60 is positioned on the first antenna 110 side (inside the room in this example) along the first axis A1 in the case where the synthetic radio wave has a wave height that is a designated wave height or higher.

As an example, the determination section 180 may compare a DC component to a designated value. The DC component is extracted from the synthetic radio wave by the detection circuit 170.

Such a configuration makes it possible to simply and inexpensively determine which one of two conflicting directions a radio wave is arrived from.

Note that, although not illustrated, in the case where the delay added by the delay line 140 is switched between the first radio wave and the second radio wave, it is also possible to determine that the radio wave has arrived from the direction of the wave height of 0 in view of the switching condition.

Most of the detection circuits have a function of outputting the wave height in logarithmic format. Accordingly, a wave height obtained by doubling an original wave form results in increase by 3 dB in the case where the two radio waves to be combined have almost the same phases. On the other hand, a wave height obtained by multiplying an original wave form by 0.01 results in decrease by 20 dB in the case where the two radio waves to be combined have almost reverse phases. Therefore, higher accuracy is obtained when a radio wave having a wave height close to zero is detected.

Accordingly, for example, it is sufficient to adopt a highly accurate detection method in which the external device 60 tends to be detected as a device positioned inside the room if it is desirable to prohibit a third person from unlocking a door because the external device 60 is erroneously determined as a device positioned outside the room and an authentication process is completed although the external device 60 is positioned inside the room actually.

### 2. Second Embodiment

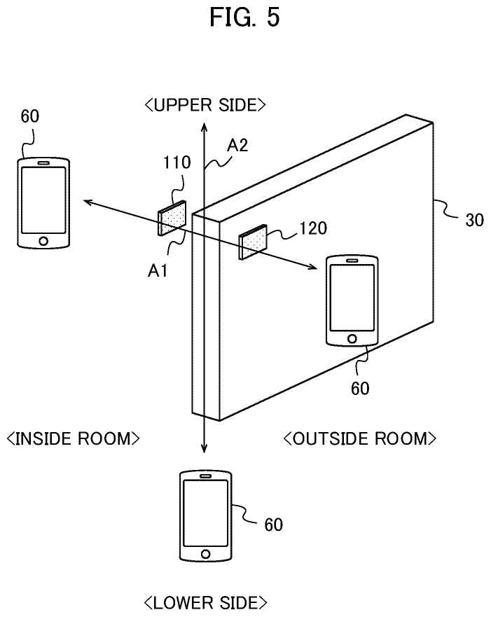

Next, an example of determination according to a second embodiment of the present invention will be described with reference to FIG. 5 to FIG. 9.

In the first embodiment, it is determined which one of the two directions along the first axis A1 the external device 60 is positioned.

On the contrary, according to the second embodiment illustrated in FIG. 5, it is determined whether the external device 60 is positioned in a direction along the first axis A1 (inside or outside the room) or in a direction along a second axis A2 (upper side or lower side) perpendicular to the first axis A1.

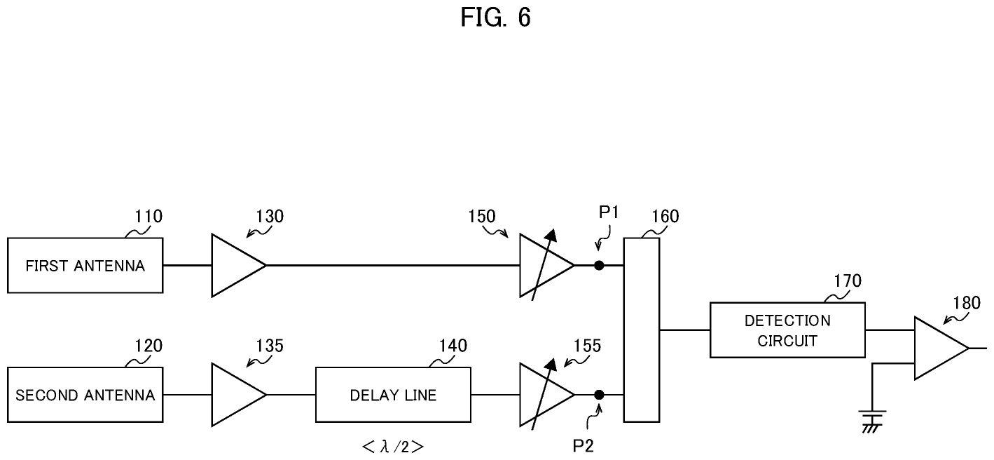

FIG. 6 is a diagram illustrating a configuration example of a determination device 10 according to the second embodiment of the present invention. The configuration of the determination device 10 according to the second embodiment is almost similar to the configuration of the determination device 10 according to the first embodiment illustrated in FIG. 2.

However, the second embodiment is different from the first embodiment in that a delay line 140 according to the second embodiment delays the second radio wave by λ/2.

In other words, one of features of the determination device 10 according to the second embodiment of the present invention is to design delay between the first radio wave and the second radio wave to be about ¼ of the wavelength λ before generating the synthetic radio wave, to further delay the second radio wave by about ½ of the wavelength λ.

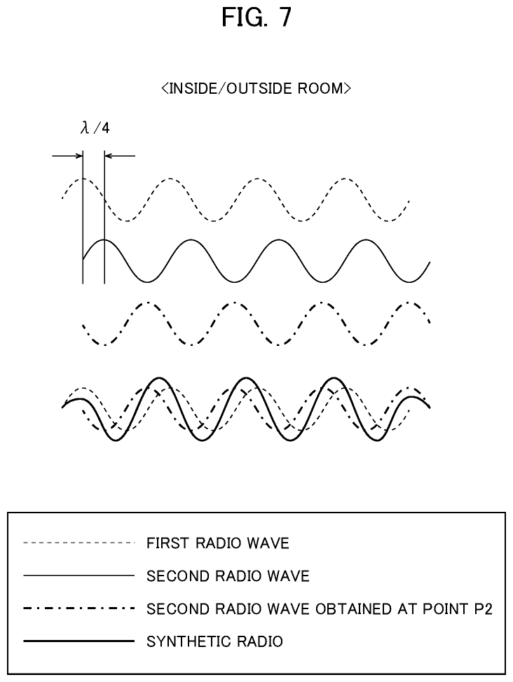

FIG. 7 is a diagram for describing a synthetic radio wave obtained in the case where the external device 60 is positioned in a direction along the first axis A1 (inside or outside the room) under the conditions illustrated in FIG. 5 and FIG. 6.

In the case where the external device 60 is positioned inside or outside the room, the second radio wave received by the second antenna 120 is delayed behind the first radio wave received by the first antenna 110 by about 214 as illustrated in FIG. 7.

Here, a second radio wave obtained at the point P2 has a phase that is almost reverse of a second radio wave received by the second antenna 120 because the delay line 140 has delayed the second radio wave by λ/2.

Accordingly, the wave height of a synthetic radio wave generated by the synthesis circuit 160 is higher than the wave heights of the first radio wave and the second radio wave as illustrated in FIG. 7.

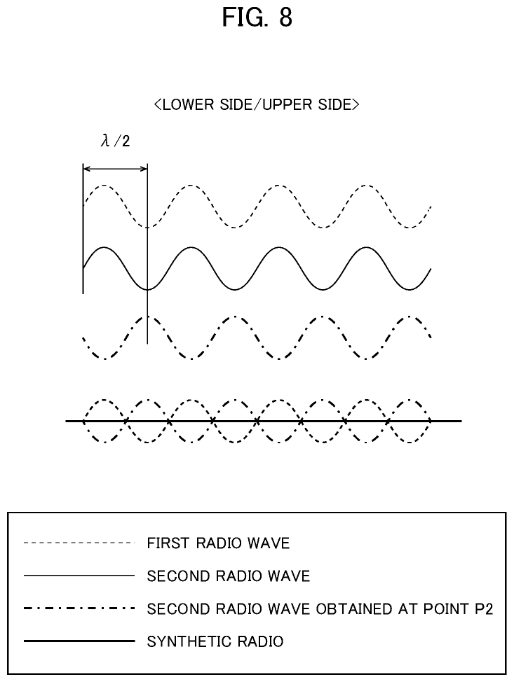

On the contrary, FIG. 8 is a diagram for describing a synthetic radio wave obtained in the case where the external device 60 is positioned in a direction along the first axis A2 (upper side or lower side) under the conditions illustrated in FIG. 5 and FIG. 6.

In the case where the external device 60 is positioned on an upper side or a lower side, the second radio wave received by the second antenna 120 has substantially the same phase as the first radio wave received by the first antenna 110 as illustrated in FIG. 8.

Here, a second radio wave obtained at the point P2 has a phase that is almost reverse of a first radio wave obtained at the point P1 because the delay line 140 has delayed the second radio wave by λ/2.

Accordingly, the wave height of a synthetic radio wave generated by the synthesis circuit 160 is higher than the wave heights of the first radio wave and the second radio wave as illustrated in FIG. 7.

Accordingly, the wave height of a synthetic radio wave generated by the synthesis circuit 160 is about zero as illustrated in FIG. 7.

Therefore, it is possible for the determination section 180 according to the present embodiment to determine that the external device 60 is positioned in the direction along the second axis A2 (upper side or lower side in this example) in the case where the synthetic radio wave has a wave height that falls below a designated wave height.

On the contrary, it is also possible for the determination section 180 according to the present embodiment to determine that the external device 60 is positioned in the direction along the first axis A1 (inside or outside the room in this example) in the case where the synthetic radio wave has a wave height that is a designated wave height or higher.

Note that, FIG. 5 illustrates the example in which the first antenna 110 and the second antenna 120 are disposed across the partition 30. However, the arrangement of the first antenna 110 and the second antenna 120 is not limited thereto.

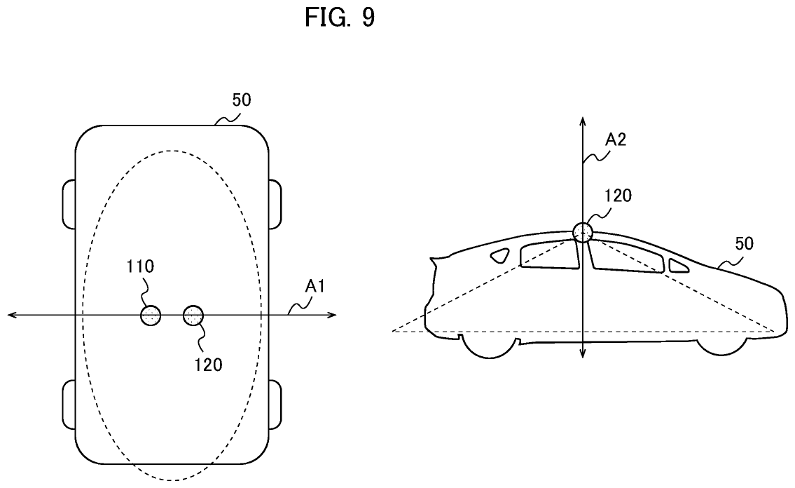

FIG. 9 is a diagram illustrating a case where the first antenna 110 and the second antenna 120 according to the present embodiment are disposed on a ceiling of a vehicle 50.

In the example illustrated in FIG. 9, a first axis A1 represents a left-right direction of the vehicle 50, and a second axis A2 represents an up-down direction of the vehicle 50.

In this case, a region below the first antenna 110 and the second antenna 120 covers almost the whole vehicle cabin of the vehicle 50.

This allows the determination section180 according to the present embodiment to determine whether or not the external device 60 is positioned inside or outside the vehicle cabin of the vehicle 50 on the basis of the synthetic radio wave.

Note that, in principle, a phase difference between the first radio wave and the second radio wave is zero in a front-rear direction of the vehicle 50. However, it is also possible to differentiate the front-rear direction from the up-down direction (inside the vehicle cabin) by installing two more antennas in the front-rear direction of the vehicle 50.

As described above, when using a system 1 according to the present embodiment, it is also possible to detect the external device 60 positioned below the first antenna 110 and the second antenna 120.

Note that, FIG. 9 illustrates the example in which the system determines whether the external device 60 is positioned inside or outside the vehicle cabin of the vehicle 50. However, the system 1 configured to determine the position of the external device 60 according to the present embodiment is not limited thereto.

For example, it is also possible for the system 1 according to the present embodiment to detect whether or not the external device 60 is positioned in a specific line in a situation where a plurality of lines is formed such as ticket gates in a station.

In other words, the system 1 according to the present embodiment makes it possible to determine whether a user carrying the external device 60 has passed through a specific line among a plurality of lines (such as ticket gates in a station) that are arrayed side by side.

The details of the determination made by the determination device 10 according to the second embodiment of the present invention has been described above.

Note that, in the first embodiment and the second embodiment, the determination conditions may further include a condition that received signal strength indicators (RSSI) of the first radio wave and the second radio wave is designated values or more.

By adding such a condition, it is possible to determine the position of the external device with higher accuracy.

### 3. Third Embodiment

Next, a third embodiment of the present invention will be described.

In the first embodiment and the second embodiment, it is possible to determine the position of the external device 60 with high accuracy in the case where an environment includes no other devices that emit radio waves than the external device 60.

However, in recent years, devices that emit radio waves such as smartphones and tablets have been widespread, and it is expected that many environments are filled with a plurality of radio waves emitted from various devices.

In the environment filled with a plurality of radio waves as described above, there is a possibility that the first antenna 110 and the second antenna 120 receive radio waves emitted from devices other than the target external device 60, and the determination device erroneously determines the position of the external device 60 on the basis of such radio waves.

To prevent the above-described erroneous position determination, it is necessary to determine whether or not radio waves received by the first antenna 110 and the second antenna 120 are desired radio waves emitted from the target external device 60.

However, for example, in the case where BLE or the like is adopted as the designated communication standard, there is a possibility that the devices other than the target external device 60 may emit radio waves compliant with the same communication standard. This makes it difficult to distinguish the radio waves emitted from the external device 60 from the radio waves emitted from the devices other than the target external device 60.

Here, it is also assumed that a radio wave having an extremely strong RSSI is treated as the desired radio wave to determine whether or not a received radio wave is the desired radio wave.

In the case of adopting such a method, a receiver configured to receive radio waves compliant with a designated communication standard may further be disposed in addition to the first antenna 110 and the second antenna 120, for example. In addition, a position determination result obtained in the case where the receiver has received a radio wave having an RSSI of a designated value or more is used.

In addition, examples of another method of determining whether or not the received radio wave is the desired radio wave may include a method of catching only a radio wave of a BLE advertising channel (such as 2402 MHz), analyzing the radio wave, and determining whether or not the analyzed radio wave is the desired radio wave.

The third embodiment of the present invention adopts the above-described determination method based on the radio wave analysis.

Alternatively, according to the first embodiment and the second embodiment, there is a possibility that a synthetic radio wave may have a strength indicating an in-phase situation even if the first radio wave has a phase that is almost reverse of the second radio wave before synthesis in the case where the radio wave 60 is extremely close to the first antenna 110 and the second antenna 120.

A configuration to be described below makes it possible to determine the position of the external device 60 with high accuracy even in the above-described situation.

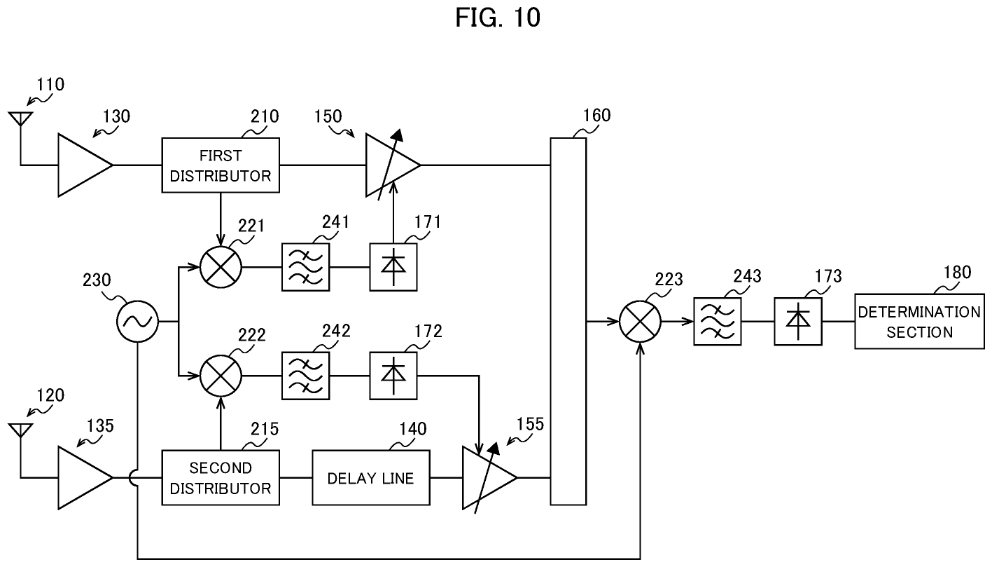

FIG. 10 is a diagram illustrating a configuration example of a determination device 10 according to a third embodiment of the present invention.

As illustrated in FIG. 10, the determination device 10 according to the third embodiment of the present invention includes a first distributor 210 configured to distribute a portion of the first radio wave.

The portion of the first radio wave distributed by the first distributor is processed by a mixer 221 connected to an oscillator 230 in such a manner that the portion of the first radio wave is in an intermediate frequency (IF) band, and then the portion of the first radio wave is input to a band-pass filter (BPF) 241.

The BPF 241 only passes center frequencies ±1 MHz in a designated frequency band of the input radio wave (for example, center frequency of 100 MHz obtained by converting 2402 MHz to the IF (100 MHz may be replaced with any value)).

The radio wave that has passed through the BPF 241 is detected by the detection circuit 171, and the first wave height adjustment circuit 150 generates gain for an amplifier on the basis of a detection result (wave height value) obtained by the detection circuit 171.

In addition, the determination device 10 according to the present embodiment includes a second distributor 215 configured to distribute a portion of the second radio wave.

The portion of the second radio wave distributed by the second distributor 215 is processed by the mixer 222, the BPF 242, the detection circuit 172, and the second wave height adjustment circuit 155 in a way similar to the above-described processes performed on the portion of the first radio wave.

The above-described configuration makes it possible to ignore most of radio waves emitted from devices other than the target external device 60, even in the case where there are the devices configured to emit radio waves compliant with the designated communication standard in addition to the target external device 60.

If radio waves having a same frequency are received by coincidence, it is difficult to determine which of the radio waves is the desired radio wave. However, in this case, a determination result obtained by the determination section 180 may be treated as a valid result only when an additional receiver (not illustrated) has received a radio wave including a designated ID.

In the example illustrated in FIG. 10, the first wave height adjustment circuit 150 and the second wave height adjustment circuit 155 of the determination device 10 uniform wave heights of radio waves in such a manner that the radio waves to be input to the synthesis circuit 160 have a certain wave height.

Therefore, it is possible to accurately determine the position of the external device 60 by using a single threshold even in the case where the radio wave 60 is extremely close to the first antenna 110 and the second antenna 120 and the first radio wave has a phase that is almost reverse of the second radio wave before synthesis.

In addition, as illustrated in FIG. 10, a synthetic radio wave generated by the synthesis circuit 160 is processed by a mixer 223 and a BPF 243, and is input to a detection circuit 173.

This is because a wave height of a radio wave having a desired frequency is treated as a determination target.

For example, in the case where it is determined that a radio wave of an advertising channel emitted from the external device 60 is a desired radio wave, it is also determined that the radio wave include a valid ID, but a device other than the external device 60 has emitted a radio wave in a different frequency band by coincidence, such a radio wave is also combined by the synthesis circuit 160.

However, by installing the mixer 223 and the BPF 243, it is possible to abandon the determination result based on the synthetic radio wave generated in the above-described situation.

### 4. Fourth Embodiment

Next, a fourth embodiment of the present invention will be described.

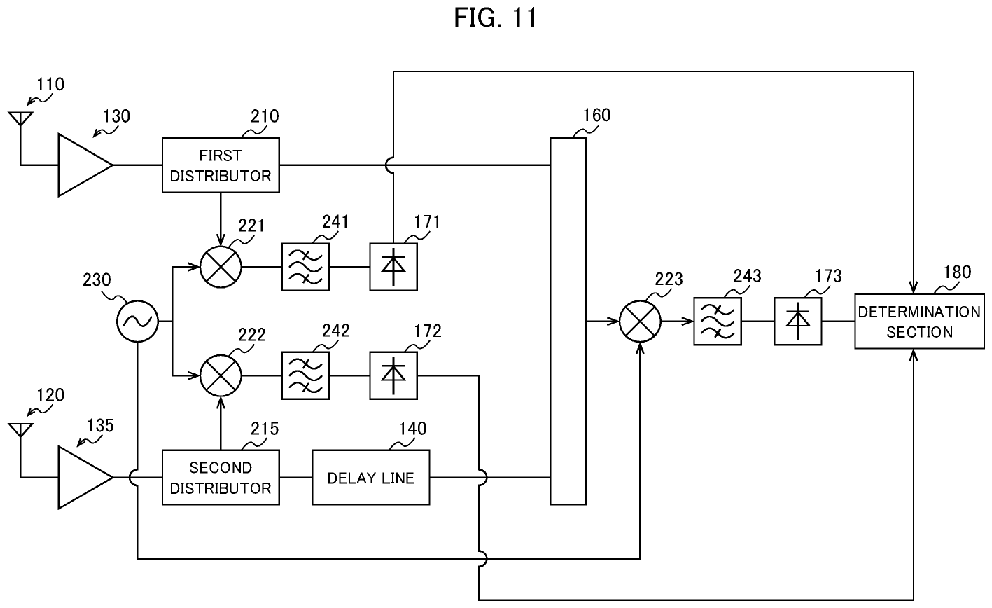

FIG. 11 is a diagram illustrating a configuration example of a determination device 10 according to the fourth embodiment of the present invention.

The determination device 10 according to the fourth embodiment is different from the third embodiment in that the determination device 10 according to the fourth embodiment does not include the first wave height adjustment circuit 150 or the second wave height adjustment circuit 115, and in that the determination section 180 receives a radio wave output from the detection circuit 171, a radio wave output from the detection circuit 172 and a radio wave output from the detection circuit 173.

The first radio wave received by the first antenna 110 and the second radio wave received by the second antenna 120 according to the present embodiment are a same radio wave emitted from the external device 60 (but the radio waves are designed intentionally in such a manner that radio waves have different phases).

However, the antennas have directivity, and the ability to receive radio waves varies depending on the directions of arrival of the radio waves. This does not guarantee that the first antenna 110 and the second antenna 120 receive radio waves having a same wave height. Accordingly, in general, a function of adjusting wave heights to a certain value is necessary (for the first wave height adjustment circuit 150 and the wave height adjustment circuit 155).

However, the determination device 10 does not have to include the first wave height adjustment circuit 150 or the second wave height adjustment circuit 155 in the case where it is not assumed that a difference between the wave height of the first radio wave and the wave height of the second radio wave is about 100 to 1000 times but it is assumed that the difference between the wave height of the first radio wave and the wave height of the second radio wave is about 2 to 20 times (about 3 to 13 dB).

As an example, a case where a first radio wave has wave height of 10 and a second radio wave has wave height of 2 will be described.

In this example, a synthetic radio wave has wave height of 12 if the phase of the first radio wave is the same as the phase of the second radio wave before synthesis.

On the other hand, a synthetic radio wave has wave height of 8 if the first radio wave has a phase that is reverse of the second radio wave before synthesis.

The determination section 180 according to the present embodiment selects a radio wave having higher wave height from among the first radio wave input from the detection circuit 171 and the second radio wave input from the detection circuit 172, and compares the wave height of the selected radio wave with the wave height of a synthetic radio wave input from the detection circuit 173.

In this example, the radio wave having the wave height of 10 is selected and compared with the wave height of the synthetic radio wave (12 is obtained in the case of the same phase, and 8 is obtained in the case of different phases).

On the basis of such comparison, the synthetic radio wave has a higher wave height (12>10) in the case where the first radio wave has the same phase as the second radio wave, but the synthetic radio wave has a lower wave height (8<10) in the case where the first radio wave has a different phase from the second radio wave.

As another example, a case where a first radio wave has wave height of 300 and a second radio wave has wave height of 15 will be described.

In this example, a synthetic radio wave has wave height of 315 if the first radio wave has a same phase as the second radio wave before synthesis. On the other hand, a synthetic radio wave has wave height of 285 if the radio waves are opposite to one another.

In addition, the synthetic radio wave has a higher wave height (315>300) if the first radio wave has the same phase as the second radio wave, but the synthetic radio wave has a lower wave height (285<300) if the radio waves are opposite to one another.

As described above, it is possible for the determination device 10 according to the present embodiment to determine the position of the external device 60 without using the first wave height adjustment circuit 150 or the second wave height adjustment circuit 155 while reducing the cost.

### 5. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

What is claimed is:

1. A determination device comprising
a determination section configured to determine a direction of a position of an external device on a basis of a synthetic radio wave obtained by combining a first radio wave and a second radio wave, the first radio wave being transmitted from the external device and received by a first antenna, the second radio wave being transmitted from the external device and received by a second antenna,
wherein delay between the first radio wave and the second radio wave is designed to be about ¼ wavelength before generating the synthetic radio wave, and the second radio wave is further delayed by about ½ wavelength.

2. The determination device according to claim 1,
wherein, by adjusting at least a distance between the first antenna and the second antenna, the delay between the first radio wave and the second radio wave is designed to be about ¼ wavelength before generating the synthetic radio wave.

3. The determination device according to claim 1,
wherein, on a basis of the synthetic radio wave, the determination section determines whether the external device is positioned in a direction along a first axis connecting the first antenna to the second antenna or a direction along a second axis perpendicular to the first axis.

4. The determination device according to claim 3,
wherein the determination section determines that the external device is positioned in the direction along the second axis in a case where the synthetic radio wave has a wave height that falls below a designated wave height.

5. The determination device according to claim 1, wherein
the first antenna and the second antenna are disposed on a ceiling of a vehicle, and
the determination section determines whether the external device is positioned inside or outside a vehicle cabin of the vehicle on a basis of the synthetic radio wave.

6. The determination device according to claim 1, wherein
the second radio wave is further delayed by about ¼ wavelength, and
on a basis of the synthetic radio wave, the determination section determines whether the external device is positioned on the first antenna side or on the second antenna side along a first axis connecting the first antenna to the second antenna.

7. The determination device according to claim 6,
wherein the determination section determines that the external device is positioned on the second antenna side along the first axis in a case where the synthetic radio wave has a wave height that falls below a designated wave height.

8. The determination device according to claim 6, wherein
the first antenna is disposed inside a room,
the second antenna is disposed outside the room, and
the determination section determines whether the external device is positioned inside or outside the room on a basis of the synthetic radio wave.

9. The determination device according to claim 1, further comprising
a synthesis circuit configured to generate the synthetic radio wave.

10. The determination device according to claim 1, further comprising:
the first antenna; and
the second antenna.

11. The determination device according to claim 1, further comprising:
a first wave height adjustment circuit configured to adjust wave height of the first radio wave to a designated wave height; and
a second wave height adjustment circuit configured to adjust wave height of the second radio wave to a designated wave height.

12. A determination method comprising
determining a direction of a position of an external device on a basis of a synthetic radio wave obtained by combining a first radio wave and a second radio wave, the first radio wave being transmitted from an external device and received by a first antenna, the second radio wave being transmitted from the external device and received by a second antenna,
wherein delay between the first radio wave and the second radio wave is designed to be about ¼ wavelength before generating the synthetic radio wave, and the second radio wave is further delayed by about ½ wavelength.
